(19) United States
(12) Patent Application Publication
(10) Pub. No.: US 2010/0209679 A1
(43) Pub. Date: Aug. 19, 2010

(54) FLEXIBLE LAMINATE SHEET MATERIALS

(76) Inventor: Thomas L. Tompkins, Woodbury, MN (US)

Correspondence Address: 3M INNOVATIVE PROPERTIES COMPANY, PO BOX 33427, ST. PAUL, MN, 55133-3427, US

(21) Appl. No.: 12/682,062

(22) PCT Filed: Oct. 10, 2008
(86) PCT No.: PCT/US08/79438

§ 371 Date: Apr. 8, 2010

Related U.S. Application Data
(60) Provisional application No. 60/980,234, filed on Oct. 16, 2007.

(51) Int. Cl. B32B 3/10; B32B 5/02; B32B 5/00; B32B 7/12; B32B 27/12

(52) U.S. Cl. 428/201; 442/1; 428/219; 428/220

(57) ABSTRACT

Flexible laminate sheet materials having a layer comprised of a film of high temperature stable polymeric material a fabric layer of non-metallic fibers, a scrim layer, and adhesive. The laminate sheet materials are useful, for example, in vehicles (for example, aircraft), insulation blankets, insulation systems, and systems for limiting exposure of flammable insulation to an ignition source.

### BACKGROUND

There are a variety of situations where it is necessary or desirable to utilize a barrier to prevent or reduce the transfer of heat and/or flame. For example, the fuselage of an aircraft generally includes a metal outer skin supported around a metal frame comprising a stringer and circumferential members. Since temperatures within the fuselage must usually be controlled in order to insure the proper environment for occupants and cargo, most fuselage shells also include some form of thermal insulation. Insulation is generally included for acoustical reasons as well. In many aircraft this insulation takes the form of fiberglass batts supported by the stringer and circumferential members.

The fiberglass is generally encased in a film bagging material to protect the fiberglass from condensate and other fluids the insulation might come into contact with. Bagging materials that have been used for such a purpose include metallized polyester, plain polyester, metallized polyvinyl fluoride, and polyimide.

In 2003, the FAA (that is, the United States Federal Aviation Administration) issued a rule FAR 25.856 (a and b) (see, for example, Department of Transportation, Federal Aviation Administration, Improved Flammability Standards for Thermal/Acoustic Insulation Materials Used in Transport Category Airplanes; Final Rule, 14 CFM Part 25, et al., Federal Register/Vol. 68, No. 147/Thursday, Jul. 31, 2003) detailed new test methods for thermal/acoustic insulation intended to increase in-flight fire safety and post-crash burn-through resistance of insulation materials on aircraft. This action is intended to enhance safety by reducing the incidence and severity of cabin fires, particularly those in inaccessible areas where thermal and acoustic insulation materials are installed, and providing additional time for evacuation by delaying the entry of post-crash fires into the cabin.

Although there have been some solutions offered to address requirements such as enhanced in-flight fire resistance and post-crash burn through protection (see, for example, U.S. Pat. No. 6,670,291 (Tompkins et al.), there exists a need for additional insulation materials and associated flame and/or fire protection materials. Preferably, these materials meet one or more of the applicable industry and/or government standards for a particular use.

### SUMMARY

The present disclosure provides flexible laminate sheet materials comprising:

a first layer comprised of a film of high temperature stable polymeric material, wherein the high temperature stable polymeric material high temperature stable polymeric material is stable (that is, does not melt, burn or decompose) at a temperature of at least 150° C. (in some embodiments, at least 200° C., 300° C., or even at least 350° C.);

a second, fabric layer comprised of non-metallic fibers;

a third, scrim layer;

a first, adhesive layer disposed between the first and second layers; and

a second, adhesive layer disposed between the second and third layers, wherein the layers are in the following order: first layer, second layer, and third layer, and wherein the third layer has a first and second generally opposed, major surfaces, the first major face being closer to the second layer than the second major face, and (a) wherein at least a portion of the second major surface is exposed or (b) wherein the second adhesive extends through the scrim, covers the second major surface of the scrim, and provides an exposed major surface of the second adhesive. The laminate sheet material is sufficiently flexible such that it retains its integrity when wrapped once around a 6 millimeter diameter rod and then unwrapped (that is, it passes the “Flexibility Test for Laminate Sheet Materials” under the “TEST PROCEDURES” heading. Typically, the flexible laminate sheet material described herein is flexible but not to the point where it is floppy.

Typically, the first, second, and third layers and first and second adhesives collectively provide the flexible laminate sheet material to have at least one of a passing Flammability Value, (that is, if the flexible laminate sheet material is subjected to the Flammability Test defined herein, it will have a passing Flammability Value), a passing Flame Propagation Value (that is, if the flexible laminate sheet material is subjected to the Flame Propagation Test defined herein, it will have a passing Flame Propagation Value), or a passing Burnthrough Value (that is, if the flexible laminate sheet material is subjected to the Burnthrough Test as defined herein, it will have a passing Burnthrough Value). The tests determining a passing Flammability Value, a passing Flame Propagation Value, and a passing Burnthrough Value are described below under the heading “TEST PROCEDURES”.

Flexible laminate sheet materials described herein are useful, for example, in a variety of situations where it is necessary or desirable to utilize a material or system to prevent or reduce the transfer of heat and/or flame. Uses include in the production of new aircraft and/or retrofitting existing aircraft to protect flammable material from potential ignition sources (for example, short circuits from electrical wiring). For existing aircraft, flexible laminate sheet materials described herein may be placed, for example, over the existing aircraft insulation material (typically a flammable insulation material) such that it is between the insulation material and a potential ignition source to reduce exposure of the insulation material from the ignition source. Flammable insulation material refers to insulation material that is inherently flammable; insulation material that has been rendered flammable at least in part due to contamination with a material that renders it flammable (for example, fuel, hydraulic fluids, and corrosion inhibitors), as well as insulation material that may or may not be inherently flammable but that has a flammable cover or layer thereon (for example, a metallized polyester cover).

In some embodiment, for example, flexible laminate sheet materials described herein, are useful in insulation systems comprising the flexible laminate sheet material and insulation material, wherein the flexible laminate sheet material and the insulation material are positioned such that the first layer of the flexible laminate sheet material is adjacent to the insulation material. The insulation material may be flammable or nonflammable.

In some embodiment, flexible laminate sheet materials described herein, are useful, for example, in systems for limiting exposure of flammable insulation material to an ignition source, wherein the system comprises the flexible laminate sheet material being positioned between the flammable insulation material and the ignition source such that the third layer of the flexible laminate sheet material is adjacent to the flammable insulation material.

In some embodiment, flexible laminate sheet materials described herein, are useful, for example, in an insulation blanket, wherein the blanket comprises the flexible laminate sheet material being positioned with respect to an insulation material such that the third layer of the flexible laminate sheet material is positioned adjacent to the insulation material. The insulation material may be flammable or nonflammable.

Some embodiments of flexible laminate sheet materials described herein are also useful, for example, to provide an aircraft comprising insulation material, electrical wiring, the flexible laminate sheet material, wherein the flexible laminate sheet material is positioned between the insulation material and electrical wiring, and wherein the third layer of the flexible laminate sheet material is adjacent to the insulation material. The insulation material may be flammable or nonflammable.

Some embodiments of flexible laminate sheet materials described herein are also useful, for example, to provide an aircraft comprising insulation material, a fuselage exterior skin, and the flexible laminate sheet material, wherein the flexible laminate sheet material is positioned between the insulation material and the fuselage exterior skin, and wherein the third layer of the flexible laminate sheet material is adjacent to the flammable insulation material. The insulation material may be flammable or nonflammable.

Advantages of embodiments of flexible laminate sheet materials described herein include the ability to thermally or ultrasonically attached (for example, welded) the scrim side of the laminate to a fourth layer (for example, the backside cover film of an insulation blanket).

### BRIEF DESCRIPTION OF THE DRAWINGS

FIG. 1 is portion of a cross-sectional view of FIG. 2, showing an exemplary flexible laminate sheet material described herein attached to a moisture barrier film of an insulation blanket.

FIG. 2 is a cross-sectional view of the insulation blanket with an embodiment of a flexible laminate sheet material described herein positioned as the outside cover of the fiberglass insulation.

FIG. 3 is a cross-sectional view of a portion of an exemplary aircraft fuselage with an embodiment of a flexible laminate sheet material described herein positioned towards the aluminum fuselage skin.

FIG. 4a is a side view schematic representation of the test chamber utilized to evaluate the Flammability and Flame Propagation characteristics of flexible laminate sheet materials described herein.

FIG. 4b is a side view schematic illustration of the retaining frame used to hold a flexible laminate sheet material described herein in place during Flammability and Flame Propagation testing.

FIG. 4c is a top view schematic illustration of the securing frame that is placed over a flexible laminate sheet material described herein and the retaining frame during Flammability and Flame Propagation testing.

FIG. 5 is a side view schematic illustration of the pilot burner used to ignite a flexible laminate sheet material described herein during Flammability and Flame Propagation testing.

FIG. 6 is a perspective view schematic illustration of the calorimeter holding frame used to position calorimeters during calibration of the Flammability and Flame Propagation test apparatus.

FIG. 6a is a perspective view schematic illustration of the burner stop used to properly position the pilot burner over a flexible laminate sheet material described herein during Flammability and Flame Propagation testing.

FIG. 7 is a perspective view schematic illustration of the specimen holder used in testing the Burnthrough characteristics of an embodiment of a flexible laminate sheet material described herein.

FIG. 8 is a side view schematic illustration of the Burnthrough Test showing an embodiment of a flexible laminate sheet material described herein undergoing the Burnthrough test.

FIG. 8a is a detailed schematic cross-section of the test frame illustrating how a flexible laminate sheet material described herein is installed in the test frame prior to Burnthrough testing.

FIG. 9a is a top view schematic illustration of the extension cone that is fitted on the burner during Burnthrough testing.

FIG. 9b is an end view of FIG. 9a taken along line 9b-9b after the cone has been formed.

FIG. 9c is an end view of FIG. 9a taken along line 9c-9c after the cone has been formed.

FIGS. 10a and 10b are top and side schematic illustrations, respectively, showing the placement of the calorimeter relative to the burner cone in the Burnthrough Test.

FIGS. 11a and 11b are top and side schematic illustrations, respectively, showing the placement of the thermocouple rake relative to the burner cone in the Burnthrough Test.

FIG. 12a is a schematic illustration of a cross-section of an embodiment of a second layer comprising non-metallic fibers infiltrated with vermiculite dispersion, which is useful in an embodiment of a flexible laminate sheet material described herein.

FIG. 12b illustrates an enlarged detail view of a portion of FIG. 12a.

FIG. 13 is a schematic illustration of a top view of a portion of an embodiment of a second layer comprising non-metallic fibers having a metal oxide coating arrayed in a discrete pattern on the surface thereof, which is useful in an embodiment of a flexible laminate sheet material described herein.

### DETAILED DESCRIPTION

Referring to FIG. 2, a cross-section of insulation blanket 19 having a fiberglass insulation 44 and first major surface 23 covered with flexible laminate sheet material described herein 9 and second major surface 12 covered with a moisture barrier film 21 and flexible laminate sheet material 9 and moisture barrier film 21 attached at bond area 8 around the perimeter of the insulation blanket encapsulating fiberglass insulation 44.

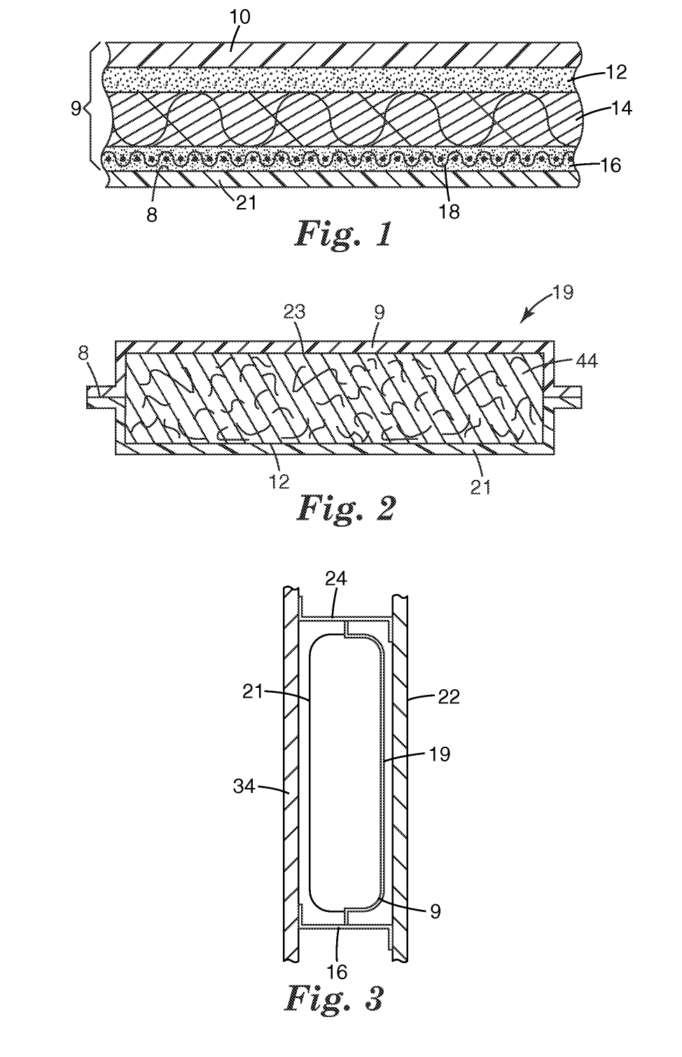

FIG. 1 shows a portion of FIG. 2. More specifically, FIG. 1 is a portion of a cross-section of flexible laminate sheet material 9 attached to moisture barrier film 21. Flexible laminate sheet material 9 comprises first layer 10 comprised of high temperature stable polymeric material, adhesive (typically a flame-retardant adhesive material) 12, second, fabric layer 14 comprised of non-metallic fibers and optional adhesive (typically a flame-retardant adhesive material) layer 16, and third, scrim layer 18. Adhesive 12 bonds first layer 10 to second layer 14. Adhesive 16 bonds second layer 14 to third layer 18. In some embodiments, adhesive 16 is embedded in third, scrim layer 18.

Typically, the first layer comprising the high temperature stable polymeric material is light in weight and demonstrates high temperature dimensional stability, little or no smoke, or combustible or toxic decomposition products upon exposure to flame, low or nonexistent moisture absorption, good abrasion resistance, and low water vapor permeability. Typically, the first layer is a fluid barrier, wherein a fluid barrier refers to a material that prevents the passage of liquids such as water, jet fuel, corrosion inhibitors, and hydraulic fluids therethrough and desirable also prevents the passage of gases including combustible gases and water vapor therethrough.

Examples of suitable high temperature stable polymeric materials include polyamides, polyvinyl fluorides, silicone resins, polyimides, polytetrafluoroethylenes (PTFEs), polyesters, polyaryl sulfones, polyetheretherketones, polyetherketoneketones, polyester amides, polyester imides, polyethersulfones, polyphenylene sulfides, and combinations thereof. In some embodiments, particularly desirable high temperature stable polymeric materials include polyvinyl fluorides and polyimides due to their greater high temperature stability. In some embodiments, high temperature stable polymeric materials are the polyimides.

Typically, the first layer has a weight of up to 100 grams per square meter (in some embodiments, up to 50 grams per square meter). The average thickness of the first layer can vary, but typically has an average thickness in a range from 6 to 125 micrometers (in some embodiments, from 6 to 50 micrometers, or even from 6 to 25 micrometers). In some embodiments, the first layer has sufficient thickness such that the layer can be easily handled and processed without tearing, but not so thick as to add unnecessary weight to the laminate sheet material.

Suitable high temperature stable polymeric materials are commercially available, and include polymide film (available, for example, under the trade designation “KAPTON” from E.I. duPont deNemours & Company, Wilmington, Del.); polyvinyl fluoride film (available, for example, under the trade designation “TEDLAR” from E.I. duPont deNemours & Company); and polytetrafluoroethylene film (available, for example, under the trade designation “TEFLON” from E.I. duPont deNemours & Company).

Typically, the non-metallic fibers in the second, fabric layer are stable (that is, do not melt, burn, or decompose) at a temperature of at least 250° C. (in some embodiments, at least 350° C., 450° C., or even at least 550° C.). Typically, the non-metallic fibers are in the form of a fabric (for example, woven fabric, knitted fabrics, or nonwoven fabric, including paper). In another aspect, the second, fabric layer is electrically non-conductive, light weight, thermal insulating, and has a gas permeability up to 460 L/min./dm2. Typically, the second, fabric layer does not readily absorb moisture and generates little or no combustible or toxic decomposition products upon exposure to a flame.

In some embodiments (for example, embodiments for aircraft applications), the second, fabric layer is comprised of a nonwoven fabric that provides a relatively thin, lighter weight laminate sheet material. Typically, the second, fabric layer has a weight in a range from 30 to 150 grams per square meter (in some embodiments, in a range from 20 to 50 grams per square meter).

In another aspect, the average thickness of the second, fabric layer can vary. Typically, the average thickness of the second layer is in a range from 75 to 750 micrometers (in some embodiments, from 125 to 500 micrometers, or even from 200 to 450 micrometers). In some embodiments, the second, fabric layer is thick enough to provide the desired Flammability, Burnthrough, and/or Flame Propagation properties but not so thick as to provide unnecessary weight to the flexible laminate sheet material.

Exemplary non-metallic fibers include glass fibers, aramid fibers, crystalline ceramic oxide (including quartz) fibers, silicon nitride fibers, silicon carbide fibers, oxidized polyacrylonitrile fibers, carbon fibers, and combinations thereof. The fibers are typically provided as individual fibers or as bundled fibers, varying in length from a few centimeters to several meters. In some embodiments, the non-metallic fibers are glass fibers, crystalline ceramic oxide fibers, or combinations thereof. It is understood that crystalline ceramic oxide fibers may contain minor amounts of glassy phases at the grain boundaries. In some embodiments, the second, fabric layer comprises primarily ceramic oxide fibers.

Ceramic oxide materials are typically metal oxides that have been consolidated by the action of heat. Ceramic oxide fibers generally refer to a class of fibers typically containing at least one oxide (for example, an oxide of aluminum, silicon, boron, etc.). Typically, the ceramic oxide fibers are crystalline ceramics and/or a mixture of crystalline ceramic and glass (that is, a fiber that contains both crystalline ceramic and glass phases).

Exemplary ceramic oxide fibers are commercially available, for example, in relatively short fibers typically referred to as “refractory ceramic fibers” (RCF). They are generally weak, friable, and not typically suitable for use in textiles (that is, woven, knitted, and nonwoven fabrics). They can also include particulate material (known as, shot). Fibers including shot are typically formed from a melt using a melt-blown method or a melt-spinning fiber forming method and subsequently cooled. In standard fiber forming methods, molten material of the desired composition is extruded resulting in fibers of relatively nonuniform length (for example, varying from about 1 micrometer to about 10 centimeters) of a relatively nonuniform diameter (for example, about 1 micrometer to about 50 micrometers). Typically, refractory ceramic fibers are provided by the manufacturer in a “staple” form (that is, as a mass of loose fibers). Examples of refractory ceramic fibers include aluminosilicate fibers available, for example, under the trade designations “7000M” from Unifrax of Niagara Falls, N.Y., and “SNSC” Type 1260 D1 RCF from Nippon Steel Chemical Co. of Tokyo, Japan.

Ceramic oxide fibers are also commercially available as relatively long (for example, continuous) fibers typically grouped together in the form of yarns (twisted fibers) or tows (nontwisted fibers). Such ceramic oxide yarns or tows typically include about 400 to about 7800 individual ceramic oxide fibers having diameters ranging from about 7 to 15 micrometers. The yarns or tows generally have a diameter of about 0.2 mm to about 1.5 mm. Yarn diameters in this range can be woven into second layers and typically have superior textile qualities, particularly as compared to the shorter refractory ceramic fibers. Ceramic oxide yarn can be ply-twisted, which means that two or more yarns are twisted together. This typically is done to increase the strength of the yarn. Examples of such continuous fibers include aluminosilicate fibers, aluminoborosilicate fibers, and alumina fibers (all of which are available, for example, under the trade designation “NEXTEL” from the 3M Company of St. Paul, Minn.).

Fiber tows or yarns can be chopped using a glass roving cutter, such as, for example, that commercially available under the trade designation “MODEL 90 GLASS ROVING CUTTER” from Finn & Fram, Inc. of Pacoima, Calif., or with scissors, to the desired length. The chopped fibers can then be separated or individualized by passing them through a waste pulling machine, which is commercially available, for example, under the trade designation “CADETTE 500” from LaRoche of Cours, France.

In some embodiments, the ceramic oxide fibers are aluminosilicate, aluminoborosilicate, and alumina fibers, and may be in the form of yarns or in the form of staple fibers. Aluminosilicate fibers are described, for example, in U.S. Pat. No. 4,047,965 (Karst et al.). In some embodiment, the aluminosilicate fibers include, on a theoretical oxide basis, about 67% to about 85% by weight Al2O3 and about 33% to about 15% by weight SiO2, based on the total weight of the aluminosilicate fibers. In some embodiments, the aluminosilicate fibers include, on a theoretical oxide basis, about 67% to about 77% by weight Al2O3 and about 33% to about 23% by weight SiO2, based on the total weight of the aluminosilicate fibers. In some embodiments, the aluminosilicate fiber includes, on a theoretical oxide basis, about 85% by weight Al2O3 and about 15% by weight SiO2, based on the total weight of the aluminosilicate fibers. Aluminosilicate fibers are commercially available, for example, under the trade designations “NEXTEL 550” and “NEXTEL 720” from the 3M Company.

Exemplary aluminoborosilicate fibers are described, for example, in U.S. Pat. No. 3,795,524 (Sowman). In some embodiments, the aluminoborosilicate fibers include, on a theoretical oxide basis, about 55% to about 75% by weight Al2O3, less than about 45% (in some embodiments up to about 44%) by weight SiO2, and less than about 25% (in some embodiments up to 5%) by weight B2O3, based on the total weight of the aluminoborosilicate fibers. Aluminoborosilicate fibers are commercially available, for example, under the trade designations “NEXTEL 312” and “NEXTEL 440” from the 3M Company.

Methods for making suitable alumina fibers are known in the art and include the method disclosed, for example, in U.S. Pat. No. 4,954,462 (Wood et al.). In some embodiments, the alumina fibers include, on a theoretical oxide basis, greater than about 99% by weight Al2O3 and about 0.2-0.3% by weight SiO2, based on the total weight of the alumina fibers. Alpha alumina fibers are available, for example, under the trade designation “NEXTEL 610” from the 3M Company. Another exemplary alpha alumina fiber, which comprises about 90 percent by weight Al2O3, amount 9 percent by weight ZrO2, and about 1 percent by weight Y2O3, based on the total weight of the fibers, commercially available from the 3M Company is that marketed under the trade designation “Nextel 650”.

Examples of other suitable inorganic fibers include: quartz fibers, which also are a subset of ceramic oxide fibers and are commercially available, for example, under the trade designation “ASTROQUARTZ” from J. P. Stevens, Inc., of Slater, N.C.; glass fibers, such as magnesium aluminosilicate glass fibers, which are commercially available, for example, under the trade designation “S2-GLASS” from Owens-Corning Fiberglas Corp. of Granville, Ohio; silicon carbide fibers, which are commercially available, for example, under the trade designations “NICALON” from Nippon Carbon of Tokyo, Japan, or Dow Corning of Midland, Mich., and “TYRANNO” from Textron Specialty Materials of Lowell, Mass.; carbon (for example, graphite) fibers, which are commercially available, for example, under the trade designation “IM7” from Hercules Advanced Material Systems of Magna, Utah; silicon nitride fibers, which are available, for example, from Toren Energy International Corp. of New York, N.Y.

In some embodiments, the second, fabric layer is desirably comprised of a nonwoven fabric. Suitable nonwoven fabrics can be made by a variety of methods, as is known in the art. In some embodiments, they are desirably made by a “wet-lay” method, or by an “air-lay” method. In a wet-lay method, fibers are mixed with a liquid medium (for example, water) and other additives (such as surfactants, dispersants, binders, and anti-flocculants) under high shear conditions. The resulting slurry of fibers is deposited onto a screen, where the liquid medium is drained away to produce a fabric. In an air-lay method, individualized fibers are fed into a web forming machine, which transports the fibers by means of an air stream onto a screen, to produce a nonwoven fabric. Such processes are well known in the art of nonwoven fabric manufacture.

In a typical wet-lay method, binder material such as thermoplastic fibers (for example, PVA fibers) are blended at high shear in water. Non-metallic fibers (chopped fibers and/or staple fibers) are added to the blender. High shear mixing typically causes at least some fibers to break, resulting in an overall reduction of fiber length. Mixing is carried out for a time sufficient to suspend the fibers in the water. Flocculating agent, such as an aqueous polyacrylamide solution, which is commercially available, for example, under the trade designation “NALCO 7530” from Nalco Chemical Co. of Naperville, Ill., can optionally be added during the mixing step to cause coagulation of the fibers if so desired. This aqueous fiber “slush” is then typically cast onto a screen (for example, a papermaker) and drained to remove the water. The resultant nonwoven fabric is pressed with blotter paper to remove as much water as possible, and then dried in an oven to further remove the water (typically, at about 100° C.). The nonwoven fabric is then ready for further processing.

In a typical air-lay method, non-metallic fibers (chopped fibers and/or staple fibers) are mixed with a binder material, particularly thermoplastic fibers, in a fiber feeder, such as that commercially available under the trade designation “CMC EVEN FEED” from Greenville Machine Corp. of Greenville, S.C., to form a feed mat. The feed mat is fed into a rotating brush roll which breaks the feed mat up into individual fibers. The individual fibers can then be transported through a blower to a conventional web forming machine, such as that commercially available under the trade designation “DAN WEB” from Scan Web Co. of Denmark, wherein the fibers are drawn onto a wire screen. While still on a screen, the fabric can be moved through an oven and heated to temperatures ranging from about 120° C. to about 150° C. for about 1 minute to melt the thermoplastic fibers and bond the fibers of the fabric together. Optionally, or alternatively, the nonwoven fabric can be compressed and heated by passing through laminating rollers, for example, to melt the thermoplastic fibers. The nonwoven fabric is then ready for further processing.

In some embodiments, and typically, at least 10% (in some embodiments, at least 20%, 25%, 30%, 40%, 50%, 60%, 70%, 75%, 80%, 90%, 95%, or even at least 100%) by weight of the non-metallic fiber content of the third, fabric layer, based on the total non-metallic fiber weight of the second, fabric layer, is comprised of fibers having a length(s) of at least 5 mm (in some embodiments, at least 1 cm). There is no known limit to the length of the fibers, although typically fibers longer than about 10-15 centimeters are not practical in nonwoven constructions of the third layer. Furthermore, as long as there are a sufficient number of fibers of at least about 5 mm in length, the second, fabric layer can also include shorter fibers of about 1 mm (and even particles of about 10-micrometer particle size).

In some embodiments, it is desirable for ceramic oxide fibers utilized in the second layer have diameters in a range from about 3 to about 25 micrometers (in some embodiments, from about 7 to about 15 micrometers). Fibers having diameters greater than about 25 micrometers are useful, but tend to have lower flexibility than those made with smaller diameter fibers. Fibers having diameters less than about 3 micrometers may also be useful but are not preferred.

Although the fibers used to prepare the second layer can be sized or unsized, the fibers are typically available in their as-received condition with a size coating present. Typically, continuous fibers are treated with organic sizing materials during their manufacture to provide lubricity and to protect the fiber strands during handling. It is believed that the sizing tends to reduce breakage of fibers and reduce static electricity during handling and processing steps. When making a non-woven fabric by wet-lay methods, the sizing tends to dissolve away. Sizing also can be removed after fabrication by heating the fabric to high temperatures (that is, 300° C.).

It is within the scope of the present disclosure for the second, fabric layer to employ one of several types of fiber, including utilizing fibers of different compositions. Typically, the second, fabric layer comprises at least 75 percent by volume (in some embodiments, at least 90, 95, or even 100 percent by volume) ceramic oxide fiber, based on the total fiber volume of the second, fabric layer.

In some embodiments, the second, fabric layer, particularly when the second layer comprises a fabric (typically a nonwoven fabric) may include a metal oxide coating on a major surface thereof, thereon metal oxide secured to the second layer. The metal oxide coating typically serves to strengthen the second layer. In some embodiments, the second layer has a first and second major surface and the metal oxide is in the form of a coating present on only a portion of at least one of the major surfaces of the second layer.

The metal oxide coating in one exemplary embodiment of the flexible laminate sheet material is positioned on only a portion of at least one surface of the second layer, producing an arrangement of discrete coated regions (also referred to herein as “printed regions”). This arrangement of the regions of metal oxide coating can be regular or random. Typically, the metal oxide coating is deposited on the second layer in a predetermined pattern using, for example, screen printing techniques and a metal oxide source (for example, a colloidal metal oxide source). An exemplary paper having metal oxide coated regions thereon is available from the 3M Company under the trade designation “NEXTEL FLAME STOPPING DOT PAPER”.

Typically, the regions of metal oxide coating are spaced apart such that the distance between any two regions (for example, any two islands) is approximately equal to the length of at least some of the fibers in the second layer, which in some embodiments is desirably a nonwoven fabric. In some embodiments, for any one surface having a metal oxide coating thereon, the percentage of surface area of that particular surface of the second layer that is coated with a metal oxide is in a range of about 5% to about 25% (in some embodiments, about 10% to about 20%). Typically, a second layer sample of about 20 centimeters square has a coating weight of a colloidal metal oxide of at least about 0.5 gram.

FIG. 13 illustrates a top view of a portion of an exemplary second layer 50 of an exemplary flexible laminate sheet material described herein having a repeating pattern of discrete regions of metal oxide coating 52 surrounded by regions of non-woven fabric 54 with substantially no coating, thereby producing islands in the form of dots, on at least one major surface of the second layer. This pattern results, for example, from a discontinuous coating of metal oxide. The islands could take other forms, such as crosses or bars.

Alternate exemplary second layers useful for flexible laminate sheet material described herein may have patterns of generally continuous lines of printing in which there are regions of a metal oxide coating next to regions of substantially no coating, on at least one major surface of the second layer. Although these patterns result, for example, from continuous coatings of metal oxide, they are still in discrete regions and coat only a portion of the surface of the second layer.

In one exemplary embodiment of a flexible laminate sheet material described herein, the metal oxide is arranged in a plurality of islands on the second layer, wherein the plurality of islands have a total surface area of about 5% to about 25%, based on the total surface area of the major surfaces of the second layer having the metal oxide coating thereon.

In another embodiment of a flexible laminate sheet material described herein, the second layer comprises a nonwoven fabric comprising at least 10% (in some embodiments, at least 20%, 25%, 30%, 40%, 50%, 60%, 70%, 75%, 80%, 90%, 95%, or even at least 100%) by weight of the non-metallic fibers that are at least 5 mm in length, wherein the metal oxide covers in a range from 5% to 25% of the total surface area of the major surfaces having the metal oxide coating thereon.

The exemplary coating pattern illustrated in FIG. 13 is to be contrasted with a coating on the entire surface of the second layer. Coating the entire surface of the second layer typically makes the resultant second layer undesirably inflexible. This typically leads to cracking and breaking of the second layer when it is handled, particularly when it must be installed into, for example, a nonplanar space.

The number, size, and position of the regions of metal oxide coating are sufficient for the second layer to retain its integrity when wrapped once around a 6 millimeter diameter rod and unwrapped. That is, after being subjected to “Flexibility Test for Second Layer” set forth in “TEST PROCEDURES”, although cracks may appear and some individual fibers may break, the second layer does not fall apart, split apart, or disintegrate into smaller portions or individual fibers.

In one exemplary embodiment, the second layer is comprised of a nonwoven fabric that includes an amount of non-metallic fibers of at least 5 mm in length, and an amount and arrangement of metal oxide coating, both of which (the amount of non-metallic fibers of at least about 5 mm in length, and the amount/arrangement of metal oxide coating) are sufficient to retain the integrity of the second layer when it is wrapped once around a 6 millimeter diameter rod and then unwrapped.

Typically, the second layer has a sufficient amount of fibers that are long enough to bridge the space between any coated regions (for example, printed metal oxide portions of the second layer).

Examples of useful metal oxide coated nonwoven fabrics are disclosed, for example, in U.S. Pat. No. 5,955,177 (Sanocki et al.). A metal oxide source which can be deposited on the second layer includes, for example, dispersion (that is, a suspension) of a colloidal metal oxide, which may also include soluble metal oxides, and/or a solution of a metal oxide precursor. Alternatively, for example, a metal oxide source does not require use of a liquid medium. That is, the metal oxide can be deposited on the second layer in a pattern through a mask, for example, using sputtering or powder coating. In some embodiments, it is desirable that the metal oxide is deposited from a metal oxide source having a liquid medium (for example, an aqueous dispersion or solution), and in some embodiments, desirable from a dispersion of colloidal metal oxide.

As used herein when describing a metal oxide coating on the second layer, the term “metal” includes metalloids, such as silicon. Precursors of metal oxides include solutions of metal salts, which may be converted by heat in an oxygen atmosphere to a metal oxide, and often a colloidal metal oxide. For example, a nitrate salt of aluminum (Al(NO3)3) can be a precursor to colloidal alumina. Colloidal metal oxides are particles of metal oxide having at least one of their dimensions in a range from 1 nanometer to 1 micrometer. Such colloidal metal oxides include alumina, zirconia, titania, silica, ceria colloids, and mixtures of these colloids. In some embodiments, colloidal silica are preferred. Suitable exemplary colloidal silica is commercially available, for example, under the trade designation “NALCO 2327” from Nalco Chemical Co. of Naperville, Ill.

In some embodiments, it is desirable that the metal oxide source is deposited by a screen printing process. A hand screen printer, or a rotoscreen printer, for example such as that commercially available, for example, under the trade designation “TYPE RMR-LAB 83” from Johannes Zimmers of Klagenfurt, Austria. The pattern and printing speed can be altered depending on the desired characteristics of the final flexible laminate sheet material.

Typically, commercially available colloidal metal oxide dispersions and/or solutions of a metal oxide precursor have viscosities that are lower than desired for a screen printing process. To increase the viscosity of such dispersions or solutions, various thickening agents, such as methylcellulose or polyvinyl alcohol, can be added. A preferred thickening agent is, for example, carboxymethyl cellulose (available, for example, under the trade designation “CARBOPOL 934” from B. F. Goodrich of Cleveland, Ohio).

Typically, the source of metal oxide (for example, colloidal metal oxide dispersion) is printed onto only a portion of at least one major surface of the second, fabric layer, although both major surfaces can each have only a portion coated with metal oxide. In some embodiments, it is desirable that the source of metal oxide is printed onto at least one major surface of the second, fabric layer as a plurality of islands (that is, discontinuous regions of coating surrounded by regions without any coating).

Typically, the metal oxide coating will at least partially penetrate into the thickness of the second, fabric layer (while still remaining in discrete regions), although if the amount of coating is small enough it may remain substantially at the surface of the second, fabric layer. At least some penetration by the metal oxide into the second, fabric layer is desirable because the penetration is believed to produce enhanced tensile strength for the second, fabric layer. For certain applications, the metal oxide coating may penetrate through the entire thickness of the second, fabric layer to the other major surface (while still remaining in discrete regions).

After depositing the source of metal oxide on the second, fabric layer, it is typically dried in air for a time sufficient to remove volatile materials, if they are present. The removal of organic materials (for example, sizing or organic binder) is not necessary. Typically, however, the second, fabric layer is heat treated at a temperature and for a time sufficient to remove substantially all the organic materials present in the second, fabric layer (for example, the organic binder). This heat treatment step is typically carried out at a temperature of at least about 500° C. for at least about 10 minutes. This heating step can also serve to at least partially convert metal oxide precursors, if used, to the corresponding metal oxide. In some embodiments, it is desirable, however, that the second, fabric layer is heat treated at a temperature and for a time sufficient to convert all of the metal oxide precursor to a metal oxide. At elevated temperatures (typically, at least 800° C.), colloidal metal oxide can also be converted to the corresponding ceramic metal oxide, although this is not a requirement. After heating at least one elevated temperature, the second, fabric layer is coated with a metal oxide and substantially no organic material.

Optionally, inorganic oxide platelets may be secured to at least a portion of the second, fabric layer. The inorganic oxide platelets can be, for example, at least one of clay platelets, vermiculite platelets, mica platelets, or talc platelets. Typically, the inorganic oxide platelets are stable (that is, do not burn, melt or decompose) at least 600° C. (in some embodiments, at least 800° C., or even at least 1000° C.). In one exemplary embodiment the second, fabric layer has both metal oxide and inorganic oxide platelets secured thereto.

In some embodiments, the inorganic oxide platelets decrease the gas permeability of the second, fabric layer. It is desirable to reduce gas permeability to decrease potential flame penetration through the second, fabric layer.

The inorganic oxide platelets may, for example, be secured to one or both sides of the second, fabric layer and/or through some or the entire thickness of the second, fabric layer. Typically, the platelets are secured to one or both sides of the second, fabric layer in addition to at least a portion of the inner thickness of the second, fabric layer. If too many platelets are secured to the second, fabric layer, the second layer may become brittle and too heavy. If not enough platelets are secured to the second, fabric layer, the desired reduction in gas permeability may not be achieved. If platelets are secured to the second, fabric layer, typically about 25 to about 70 percent (in some embodiments, about 30 to about 50 percent) by weight are included based upon the total weight of the second, fabric layer (excluding the weight of the platelets).

In some embodiments, sufficient platelets are secured to the second, fabric layer to provide a gas permeability of up to 760 L/min./dm2 (in some embodiments, up to 460 L/min./dm2). The platelets may be bonded to the second, fabric layer by a number of different methods such as chemically (for example, via hydrogen bonding) or via a binder such as a polyvinyl alcohol, or acrylate latex. Alternatively, or in addition, the fibers themselves can be used to secure the platelets to the second, fabric layer. This can occur, for example, by mixing together fibers and platelets and applying sufficient heat and pressure to form the second, fabric layer having the platelets secured thereto.

As mentioned above vermiculite platelets may optionally be secured to at least a portion of the second, fabric layer. Vermiculite is a hydrated magnesium aluminosilicate, micaceous mineral found in nature as a multilayer crystal. Vermiculite typically comprises by (dry) weight, on a theoretical oxide basis, about 38-46% SiO2, about 16-24% MgO, about 11-16% Al2O3, about 8-13% Fe2O3, and the remainder generally oxides of K, Ca, Ti, Mn, Cr, Na, and Ba. “Exfoliated” vermiculite refers to vermiculite that has been treated, chemically or with heat, to expand and separate the layers of the crystal, yielding high aspect ratio vermiculite platelets. These platelets optionally can be ground up to produce small particulate, typically ranging in size (that is, length and width) from about 0.3 micrometer to about 100 micrometers, with a mean size of about 20 micrometers. This small particulate is still considered to be in “platelet” form as that term is used herein. The thickness of a platelet typically ranges from about 10 Angstroms to about 4200 Angstroms. The vermiculite can be applied to the second, fabric layer, for example, by dispersing vermiculite platelets in a liquid medium (typically water), and applying (for example, coating) the dispersion onto the second, fabric layer. Aqueous vermiculite particle dispersions are available, for example, from W. R. Grace of Cambridge, Mass., under the trade designation “MICROLITE 963”. The desired concentration of the dispersion can be adjusted by removing or adding liquid media thereto.

The vermiculite can be applied to the second, fabric layer using conventional techniques such as dip coating, spray coating, and brush coating. In some embodiments, the vermiculite is “worked into” or uniformly distributed into the second, fabric layer. For example, the vermiculite can typically be forced into the second, fabric layer by pressure (for example, by using a conventional hand held roller; by hand flexing the coated fabric back and forth; and/or by passing the vermiculite coated second, fabric layer between two opposed rolls positioned, or capable of being positioned, such that the gap between is less than the thickness of the coated second, fabric layer). Optionally, the vermiculite dispersion can be heated to a temperature below the boiling point of the liquid media before it is applied to the second, fabric layer. Further, the coated second, fabric layer can be at an elevated temperature (for example, a temperature at or above the boiling point of the liquid media in the dispersion) before, and/or while the pressure is being applied.

In one exemplary method for coating the second, fabric layer is to dip the second layer into a vermiculite dispersion for at least several seconds, remove the second, fabric layer from the dispersion, allow excess dispersion material to drain off, and then dry the coated second layer in an oven (for example, at 95° C. for 2 hours).

In another method, vermiculite can be applied to the second, fabric layer using conventional techniques, and prior to drying, the vermiculate coated second, fabric layer can be run between two opposed rolls positioned, or capable of being positioned, such that the gap therebetween is less than the thickness of the coated second, fabric layer. In one exemplary embodiment, the coated second, fabric layer is at an elevated temperature (for example, a temperature at or above the boiling point of the liquid media in the dispersion) before, and/or while it is passed between the rolls.

Coating with vermiculite dispersion at a low concentration tends to distribute the vermiculite platelets at the intersections of the individual fibers in the second, fabric layer (for example, nonwoven paper). In areas where at least three fibers intersect, the vermiculite dispersion can bridge the region between the fibers and on removal of the liquid media, dry to a thin inorganic film that is transparent until heated. In some embodiments, these bridged areas desirably disrupt the air flow and reduce the permeability through the second, fabric layer, but desirably do not make the second, fabric layer so brittle that it fails the “Flexibility Test for Laminate Sheet Material.”

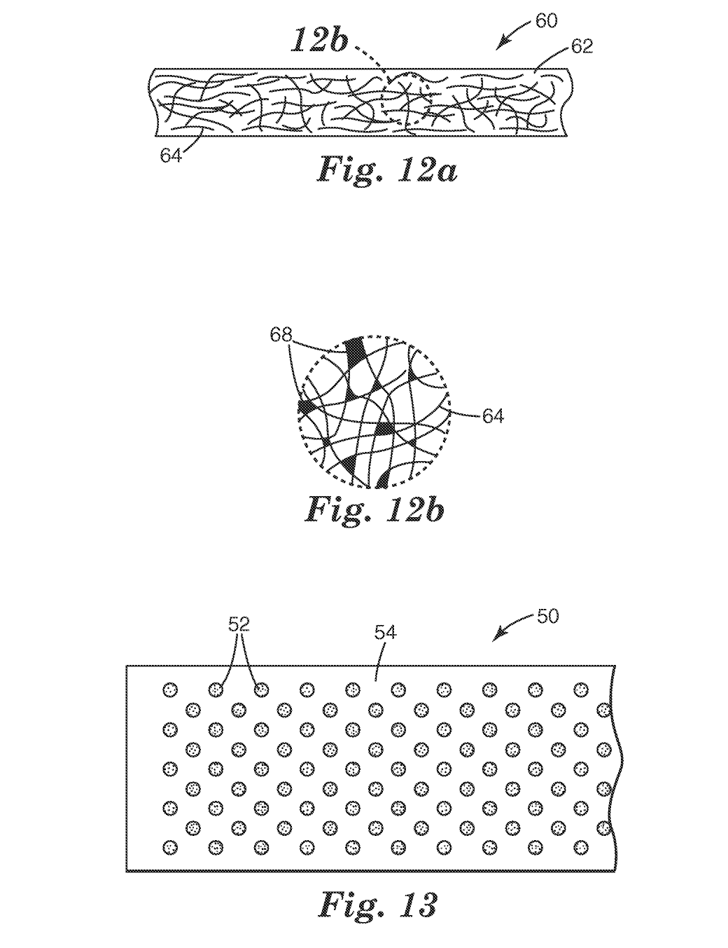

FIG. 12a is a cross-sectional view of an exemplary portion of second, fabric layer 60 comprised of non-woven fabric 62 comprising fibers 64 that has been impregnated with vermiculite dispersion and then dried. FIG. 12b, which is an enlarged detailed view of a portion of second, fabric layer 60 showing bridging areas 68 of a thin vermiculite film at multiple (at least three) fiber 64 intersections.

In some exemplary embodiments, clay platelets are secured to at least a portion of the second, fabric layer. The clay can be secured to the fabric in a similar manner as the vermiculite platelets discussed above. Examples of useful clays include kaolins, ball, hydrated aluminum silicate, kaolinite, atapulgite, illite, halloysite, beidelite, nontronite, hectorite, hectite, bentonite, saponite, montmorillonite, and combinations thereof.

In some exemplary embodiments, mica platelets are secured to at least a portion of the second, fabric layer. The mica can be secured to the second, fabric layer in a similar manner as the vermiculite platelets discussed above. Examples of useful micas include phlogoplic micas, muscovite micas, and combinations thereof. Mica coated papers are commercially available.

In some exemplary embodiments, talc platelets are secured to at least a portion of the second, fabric layer. The talc platelets can be secured to the second, fabric layer in a similar manner as the vermiculite platelets discussed above.

The scrim of the third, scrim layer is typically a woven reinforcement made from fibers, and aids in providing tear resistant properties to the flexible laminate sheet material. Suitable scrim materials include nylon, polyester, and fiberglass. The average thickness of the scrim can vary. Typically, the average thickness of the scrim is in a range from 25 to 100 micrometers (in some embodiments from 25 to 50 micrometers). Typically it is desirable for the scrim layer to be light weight, strong, and at least relatively nonflammable. Typically it is desirable that the scrim generates little or no smoke, or combustible or toxic decomposition products when exposed to flame.

A number of high temperature stable polymeric films having a scrim attached thereto via an adhesive material (which the second layer referred to above) are commercially available. Examples include those available under the trade designations “INSULFAB 2000” and “INSULFAB KP121”, from Chase Coating & Laminating, Patterson, N.J., both of which comprise a polyimide film, a nylon scrim, and a flame-retardant adhesive material. Another example is that available under the trade designation “INSULFAB 330”, commercially available from Chase Coating & Laminating which comprises a metallized polyvinyl fluoride film, a nylon scrim, and a flame-retardant adhesive material. Further, a polyetherketoneketone (“PEKK”) film, a nylon scrim and flame retardant adhesive material combination is available, for example, under the trade designation “LAMAGARD 30” from Lamart Corporation, Clifton, N.J., and a polyyvinylfloride film, nylon scrim, and flame-retardant adhesive combination is available under the trade designation “TERUL 18” from Jehier Division of Hutchinson Worldwide in France.

Typically, the adhesives are flame-retardant adhesive materials, which are adhesive materials that contain a flame-retardant additive(s) in a sufficient amount such that the adhesive material will not support combustion. Representative examples of such additives include antimony compounds, hydrated alumina compounds, amines, borates, carbonates, bicarbonates, inorganic halides, phosphates, sulfates, organic halogens and organic phosphates. A continuous or discontinuous layer of flame-retardant adhesive material may be used to bond layers within the flexible laminate sheet material. Typically the adhesives are generally coextensive with the layers they are bonding together, and a continuous layer of adhesive material is used for uniformity reasons. Suitable adhesives are commercially available. Exemplary adhesives include heat and/or ultrasonically sealable adhesives such as those commercially available, for example under the trade designation “BOSTIK THERMOGRIP® 1101,” “BOSTIK THERMOGRIP® 1165,” and “BOSTIK THERMOGRIP® 1175” from Bostik Incorporated, Middleton, Mass., and “KYNAR®” (a heat sealable, water vapor and flame propagation resistant polyvinylfluoride water-based emulsion) from Elf Atochem North America, Inc., King of Prussia, Pa.

In some exemplary embodiments, the flexible laminate sheet materials described herein have a weight up to 500 grams per square meter (in some embodiments, up 400, 350, 300, 250, 200, or even up to 150 grams per square meter. In another aspect, in some embodiments, the average thickness of the flexible laminate sheet material ranges from 75 to 1200 micrometers, from 125 to 625 micrometers, or even from 200 to 450 micrometers.

In some exemplary embodiments, the flexible laminate sheet material is essentially nonabsorbent. It is not desirable for the flexible laminate sheet material to absorb water or other fluids that it may come into contact with.

Typically, the flexible laminate sheet material described herein if tested according to the “TEST PROCEDURES” section later herein will have at least one of a passing Flammability Value, Flame Propagation Value, or Burnthrough Value.

Embodiments of the flexible laminate material described herein can be utilized in the production of new aircraft and/or retrofitting existing aircraft to protect flammable material from potential ignition sources (for example, short circuits from electrical wiring). For existing aircraft, flexible laminate sheet material described herein may be placed, for example, over the existing aircraft insulation material (typically a flammable insulation material) such that it is between the insulation material and a potential ignition source to reduce exposure of the insulation material from the ignition source.

As discussed above, for example, in regard to FIG. 1, flexible laminate sheet material as described herein can be attached (for example, thermally or ultrasonically) to an insulation blanket or form the outer cover of the blanket itself. Suitable techniques for attaching (for example, thermal or ultrasonic) the flexible laminate sheet material and insulation blanket together are well known in the art. In some embodiments, and desirably, the Thermal and/or Ultrasonic bond strength (preferably both) (as determined by the T-peel test described in the working Examples section, below) between the flexible laminate sheet material and insulation blanket is at least 10 Newton (in some embodiments, at least 11, 12, 13, 14, 15, 16, 17, 18, or even at least 19 Newton; in some embodiments, in a range from 10 to 19 Newton).

For example, FIG. 3 illustrates a cross-sectional view of a portion of an aircraft. Positioned against outer fuselage skin 22 and inner wall panel 34 and between frames 24 and 26 is insulation blanket 19 with flexible laminate sheet material described herein 9 attached thereto. Insulation blanket 19 comprises fiberglass insulation (not shown) encased within. The purpose of the moisture barrier film outer cover 21 is to protect the fiberglass insulation from condensation and other fluids it may come into contact with.

Suitable insulation blankets are known in the art, and are commercially available, for example, under the trade designation “ORCOTEK STRIP BLANKETS AND AIRFRAME INSULATION KITS” from Orcon Aerospace, Union City, Calif. In some embodiments, and desirably, the outer layer of the insulation blanket comprises a film of high temperature stable polymeric material, although other materials, such as polyester, may also be useful. For additional details on suitable high temperature stable polymeric materials see, for example, the discussion regarding the construction of the first layer above.

Advantages and embodiments of this invention are further illustrated by the following examples, but the particular materials and amounts thereof recited in these examples, as well as other conditions and details, should not be construed to unduly limit this invention. All parts and percentages are by weight unless otherwise indicated.

### EXAMPLES

### Test Procedures

### Flexibility Test for Laminate Sheet Material

A piece of the laminate sheet material 2.5 cm in width and 15.2 cm in length is wrapped once around the circumference of a 6 millimeter diameter rod (approximately the diameter of a pencil) and unwrapped. The laminate passes this test if it can be wrapped around the rod and unwrapped without a portion of the laminate sheet material exhibiting sufficient cracking and delamination or separation from adjacent layers to allow portions of the laminate to fall away or separate from the laminate construction.

### Flexibility Test for Second Layer

A piece of the second layer 2.5 cm in width and 15.2 cm in length is wrapped once around the circumference of a 6 millimeter diameter rod (approximately the diameter of a pencil) and unwrapped. Although cracks may appear and some individual fibers may break, the second layer will pass this test if it does not fall apart, split apart, or disintegrate into smaller portions or individual fibers.

### Flammability Test and Flame Propagation Test

The Flammability Values and Flame Propagation Values of laminate sheet materials were evaluated by fabricating a insulation blanket using the laminate material as the top moisture barrier cover over a thermal/acoustic insulation batt. The thermal/acoustic insulation batt had two 25 mm layers of a fiberglass insulation material, totaling (51 mm) thick.

The following test methods for the Flammability Test and Flame Propagation Test are based on FAR 25.856 (a) (see, for example, Department of Transportation, Federal Aviation Administration, Improved Flammability Standards for Thermal/Acoustic Insulation Materials Used in Transport Category Airplanes; Final Rule, 14 CFM Part 25, et al., Federal Register/Vol. 68, No. 147/Thursday, Jul. 31, 2003). This regulation requires enhanced in-flight fire resistance and post-crash burn through protection.

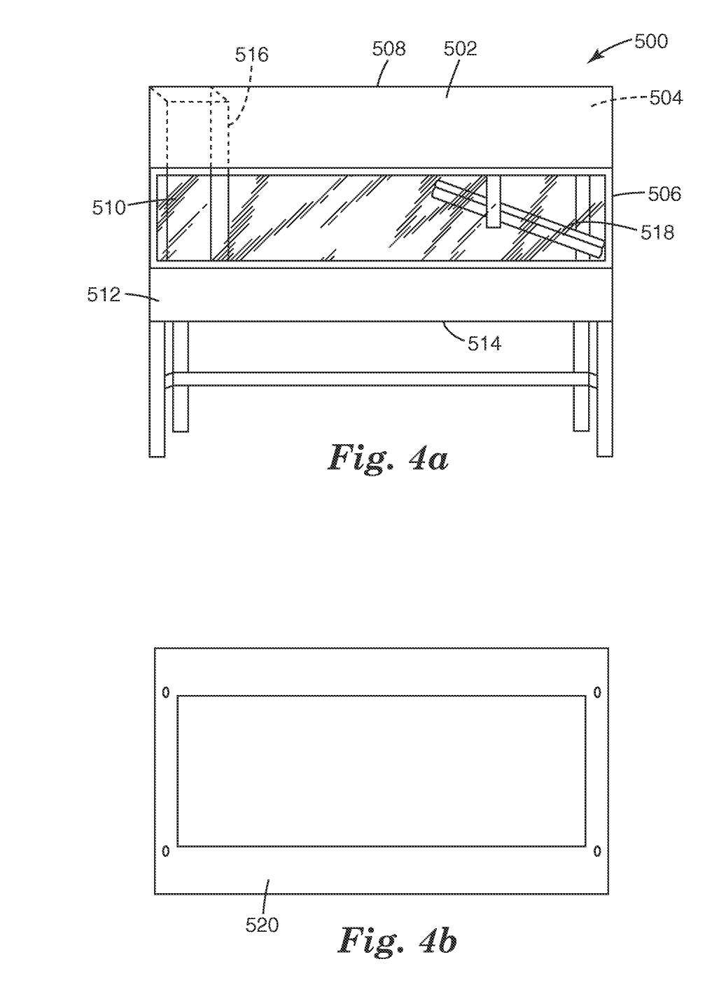

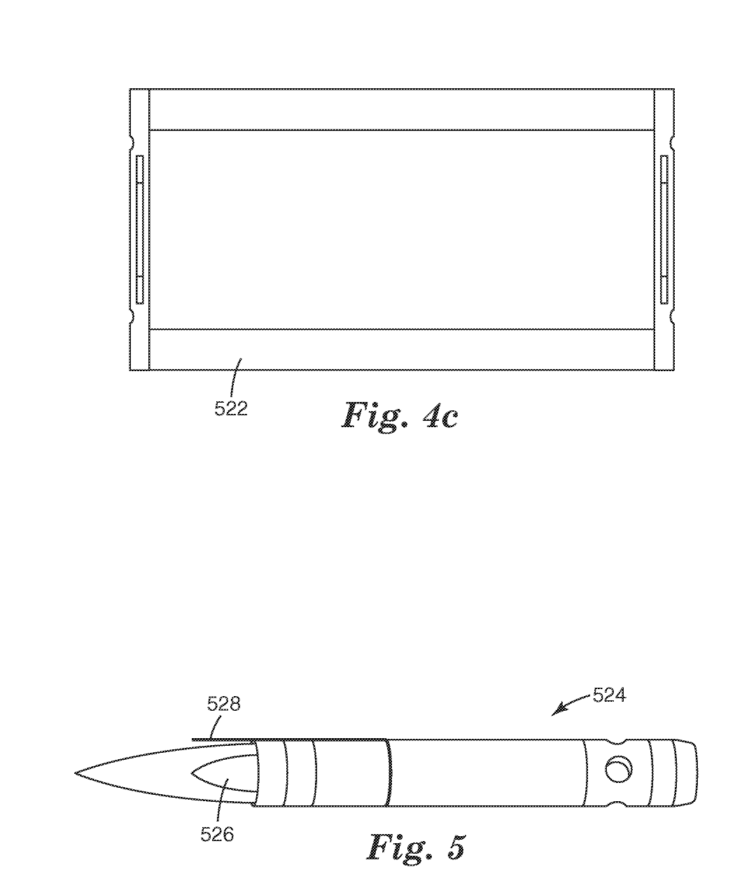

A schematic of the test apparatus is shown in FIG. 4a. Radiant panel test chamber 500 was located under an exhaust hood to facilitate clearing the chamber of smoke after each test. The radiant panel test chamber had enclosure 502, 55 inches (1400 mm) long by 19.5 inches (500 mm) deep by 28 inches (710 mm) above the test specimen. Sides 504, ends 506, and top 508 were insulated with a thermal insulation board (available under the trade designation “KAOWOOL M”). The front side was provided with an approximately 52-by 10-inch (1321 by 254 mm) draft free, high temperature, glass observation window 510, to facilitate viewing the sample during testing. Below the window was door 512, which provided access to the movable specimen platform holder. The bottom of the test chamber had sliding steel platform 514, which had provisions for securing the test specimen holder in a fixed and level position. The chamber also has internal chimney 516 with exterior dimensions of 5.1 inches (129 mm) wide, by 16.2 inches (411 mm) deep by 13 inches (330 mm) high at the opposite end of the chamber from radiant energy source 518. The interior dimensions were 4.5 inches (114 mm) wide by 15.6 inches (395 mm) deep. The chimney extended to the top of chamber 500.

Radiant heat energy source 518 was a panel of porous refractory material mounted in a cast iron frame or equivalent. The panel had a radiation surface of 12 inches by 18 inches (305 mm by 457 mm) capable of operating at temperatures up to 1500° F. (816° C.). The radiant panel fuel was propane (liquid petroleum gas-2.1 UN 1075). The panel fuel system had a venturi-type aspirator for mixing gas and air at approximately atmospheric pressure. Instrumentation included an air flow gauge, an air flow regulator, and a gas pressure gauge. The radiant panel was mounted in the chamber at 30° to the horizontal specimen plane.

Sliding platform 514 served as the housing for test specimen placement. Brackets 516 were attached (via wing nuts) to the top lip of the platform in order to accommodate various thicknesses of test specimens. A sheet of refractory material was placed on the bottom of the brackets to hold the test specimen and adjust for height requirement. A ½ inch (13 mm) piece of thermal insulation board (“KAOWOOL M”) measuring 41½ by 8¼ inches (1054 by 210 mm) was attached to the back side of the platform. This board served as a heat retainer and protected the test specimen from excessive preheating.

The test specimen was placed horizontally on the refractory base and stainless steel retaining frame 520, as shown in FIG. 4b, (AISI Type 300 UNA-NO8330) having a thickness of 0.078 inches (1.98 mm) and overall dimensions of 44¾ by 12¾ inches (1137 by 320 mm) with a specimen opening of 40 by 7⅞ inches (1016 by 140 mm) placed on top of the test specimen. The retaining frame had two ½ inch (12.7 mm) holes drilled at each end for positioning the frame to the two stud bolts at each end of the sliding platform. A securing frame 522, as shown in FIG. 4c, constructed of mildsteel was placed over the test specimen. The securing frame overall dimensions were 42½ by 10½ inches (1080 mm by 267 mm) with a specimen opening of 39½ by 7½ inches (1003 mm by 190 mm). It was not necessary to physically fasten the securing frame over the test specimen due to the weight of the frame itself.

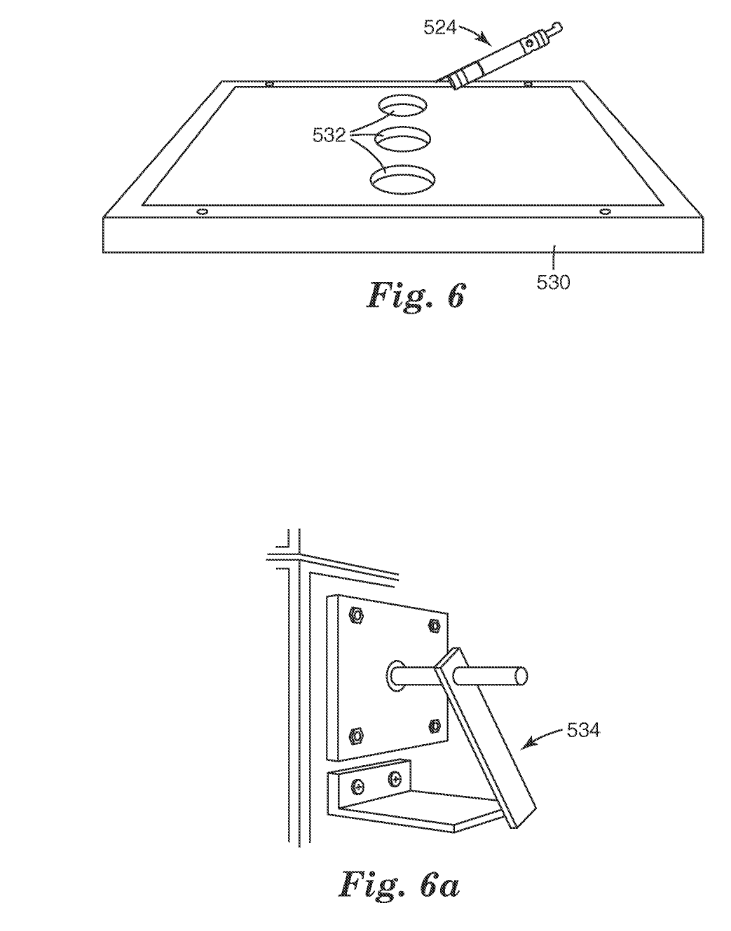

Pilot burner 524, as shown in FIG. 5, used to ignite the specimen was a commercial propane venturi torch (available under the trade designation “BERNZOMATIC”) with an axially symmetric burner tip having a propane supply tube with an orifice diameter of 0.006 inch (0.15 mm). The length of the burner tube was 2⅞ inches (71 mm). The propane flow was adjusted via gas pressure through an in-line regulator to produce a blue inner cone 526 length of ¾ inch (19 mm). A ¾ inch (19 mm) guide 528 (such as a thin strip of metal) was spot welded to the top of the burner to aid in setting the flame height. A lever 534 was used to move pilot burner 524 out of the ignition position so that the flame was horizontal and at least 2 inches (51 mm) above the specimen plane (see FIG. 6a).

A 24 American Wire Gauge (AWG) Type K (Chromel-Alumel) thermocouple was installed in the test chamber for temperature monitoring. It was inserted into the chamber through a small hole drilled through the back of the chamber. The thermocouple was placed such that it extended 11 inches (279 mm) out from the back of the chamber wall, 11½ inches (292 mm) from the right side of the chamber wall, and was 2 inches (51 mm) below the radiant panel.

The calorimeter was a one inch (25 mm) cylindrical water-cooled, total heat flux density, foil type Gardon Gage that had a range of 0 to 5 BTU/ft2-second (0 to 5.6 Watts/cm2) served as a calorimeter. The calorimeter conformed to the following specifications:
(a) Foil diameter was 0.25±0.005 inches (6.35±0.13 mm).
(b) Foil thickness was 0.0005±0.0001 inches (0.013±0.0025 mm).
(c) Foil material was thermocouple grade Constantan.
(d) Temperature measurement was a Copper Constantan thermocouple.
(e) The copper center wire diameter was 0.0005 inches (0.013 mm).
(f) The entire face of the calorimeter was lightly coated with “Black Velvet” paint having an emissivity of 0.96 or greater.

The calibration method was by comparison to a like standardized transducer.

With the sliding platform pulled out of the chamber, calorimeter holding frame 530, as illustrated in FIG. 6, was installed. The frame was 13⅛ inches (333 mm) deep (front to back) by 8 inches (203 mm) wide and rested on the top of the sliding platform. It was fabricated of ⅛ inch (3.2 mm) flat stock steel and had an opening that accommodates a ½ inch (12.7 mm) thick piece of thermal insulation board (“KAOWOOL M”) board, which was level with the top of the sliding platform. The board had three 1 inch (25.4 mm) diameter holes 532 drilled through the board for calorimeter insertion. The distance from the outside frame (right side) to the centerline of the first hole (“zero” position) was 1⅞ inches (47 mm). The distance between the centerline of the first hole to the centerline of the second hole is 2 inches (51 mm). It is also the same distance from the centerline of the second hole to the centerline of the third hole.

A computerized data acquisition system was used to measure and record the outputs of the calorimeter and the thermocouple. The data acquisition system recorded the calorimeter output every second during calibration. A stopwatch, accurate to ±1 second/hour, was used to measure the time of application of the pilot burner flame.

The test results were based on the average of 3 test specimens. Test specimen blankets were constructed from the fire barrier laminate placed on top of 2 inch (2.5 cm) thick fiberglass batts and attached to a moisture barrier film (obtained from Chase Corporation, Paterson, N.J., under the trade designation “INSULFAB 332”) on the back side of the fiberglass. These blankets had of two 1 inch (2.5 cm) layers of fiberglass in an outer bag made from metallized polyinylfloride film (“INSULFAB 332”). The metallized polyinylfloride film (“INSULFAB 332”) formed the bottom surface of the bag and the laminate formed the upper test surface of the bag. The edges were heat sealed (using a Vertrod thermal impulse sealer along the circumference. The test blankets measured 23 inches long (584 mm) by 12.5 inches (318 mm) wide.

The specimens were conditioned at 70±5° F. (21±2° C.) and 55%±10% relative humidity, for 24 hours prior to testing.

The calorimeter holding frame was installed along with the calorimeter in the first hole (“zero” position) (see FIG. 6). The centerline of the calorimeter was 1⅞ inches (46 mm) from the end of the holding frame. The distance from the centerline of the calorimeter to the radiant panel surface at this point was 7.5 inches±⅛ (191 mm±3). Prior to igniting the radiant panel, the calorimeter face was clean and water was running through the calorimeter.

The radiant panel was ignited and the fuel/air mixture was adjusted to achieve 1.5 BTU/ft2-second±5% (1.8 Watts/cm2±5%) at the “zero” position. The unit was allowed to reach steady state (approximately 90 minutes) during which time the pilot burner was off. After steady-state conditions were reached, the calorimeter and calorimeter holder fixture were removed.

The pilot burner was ignited, ensuring that it was at least 2 inches (51 mm) above the top of the platform. The pilot was adjusted so that the blue cone of the flame was ¾ inch (19 mm) in length. The test specimen was placed in the sliding platform holder, ensuring that the test sample surface was level with the top of the platform. At “zero” point, the specimen surface was 7½ inches±⅛ inch (191 mm±3 mm) below the radiant panel. The retaining frame was placed over the test specimen. The securing frame was also used. The sliding platform was pushed into the chamber to close the bottom door. The pilot burner flame was lowered into contact with the center of the specimen at the “zero” point and simultaneously the timer was started. The pilot burner was at a 27° angle with the sample and was ½ inch (12 mm) above the sample. Stop 534, as shown in FIG. 6a, allowed the operator to position the burner in the correct position each time. The burner was left in position for 15 seconds and then removed to a position 2 inches (51 mm) above the specimen.

For the sample to pass the Flame Propagation (that is, have a Flame Propagation Value of zero (0)), no flaming beyond 2 inches (51 mm) to the left of the centerline of the point of pilot flame application must be observed. For the sample to pass the Flammability Test (that is, have a Flammability Value of zero (0)), none of the three test specimens may have an after flame that exceeds 3 seconds.

### Burnthrough Test

FAR 25.856 (b) (see, for example, Department of Transportation, Federal Aviation Administration, Improved Flammability Standards for Thermal/Acoustic Insulation Materials Used in Transport Category Airplanes; Final Rule, 14 CFM Part 25, et al., Federal Register/Vol. 68, No. 147/Thursday, Jul. 31, 2003) details test requirements to demonstrate fire penetration resistance.

The following test method, based on FAR 25.856 (b), was used to evaluate the burnthrough resistance characteristics laminate sheet materials when exposed to a high intensity open flame.

The burnthrough time was measured at the inboard side of each of the laminated sheet material specimens. The burnthrough time was defined as the time required, in seconds, for the burner flame to penetrate the test specimen, and/or the time required for the heat flux to reach 2.0 Btu/ft2-sec (2.3 W/cm2) on the inboard side, at a distance of 12 inches (305 mm) from the front surface of the laminate sheet material test frame, whichever is sooner. A specimen set had two blankets fabricated from the laminate sheet material on the hot surface, two layers of 25 mm fiberglass, and metallized polyinylfloride film (“INSULFAB 332”) on the cold side. The specimens were placed on the burnthrough test rig 540, at an angle of 30° with respect to vertical and clipped in place.

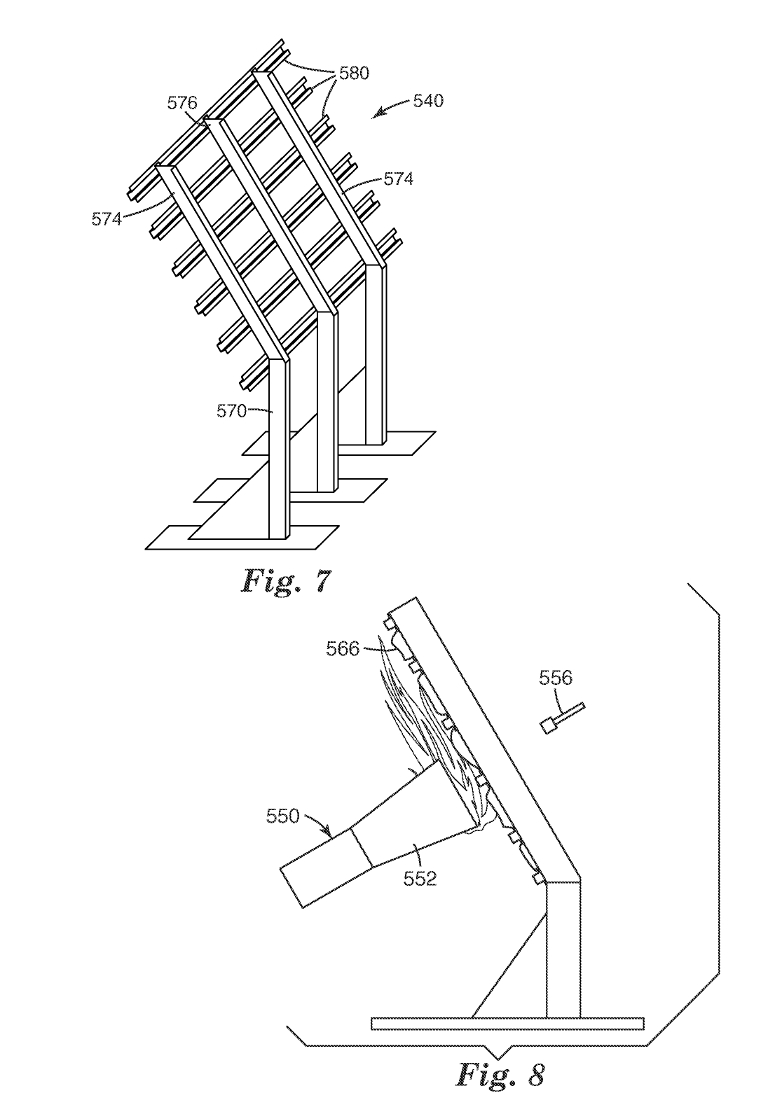

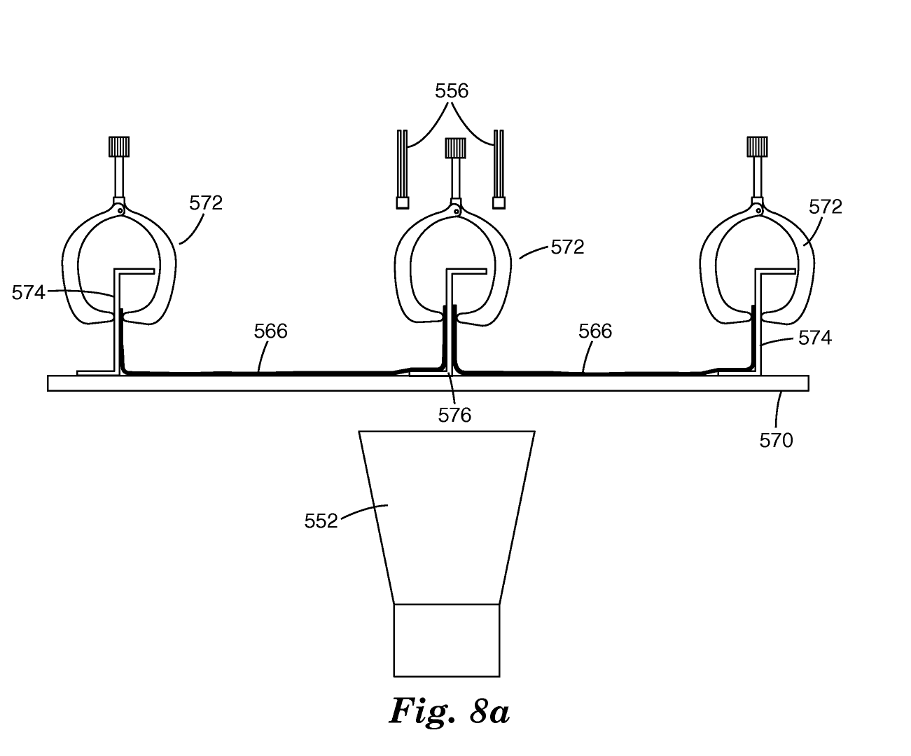

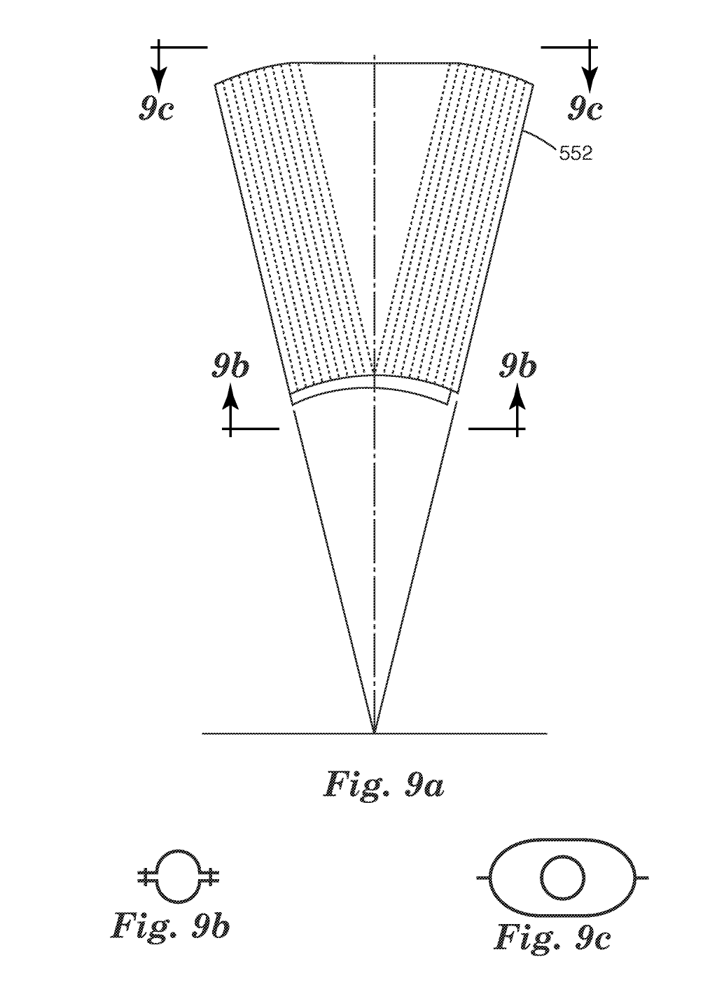

The arrangement of the test apparatus is shown in FIGS. 7 and 8 and included swinging the burner away from the test specimen during warm-up. The test burner 550 was a gun-type (available under the trade designation “PARK MODEL DPL 3400”) modified per the test procedure description. A nozzle was required to maintain the fuel pressure to yield a nominal 6.0 gal./hr. (0.378 L/min.) fuel flow. A Monarch manufactured 80° PL hollow cone nozzle nominally rated at 6.0 gal./hr. (0.378 L/min) at 100 lb/in2 (0.71 MPa) was used. A 12±0.125-inch (305±6 mm) burner extension cone 552 is shown in FIGS. 9a, 9b, and 9c was installed at the end of the draft tube. The cone had an opening 6±0.125-inch (152±6 mm) high and 11±0.125-inch (280±6 mm) wide. Jet A was used as the fuel.

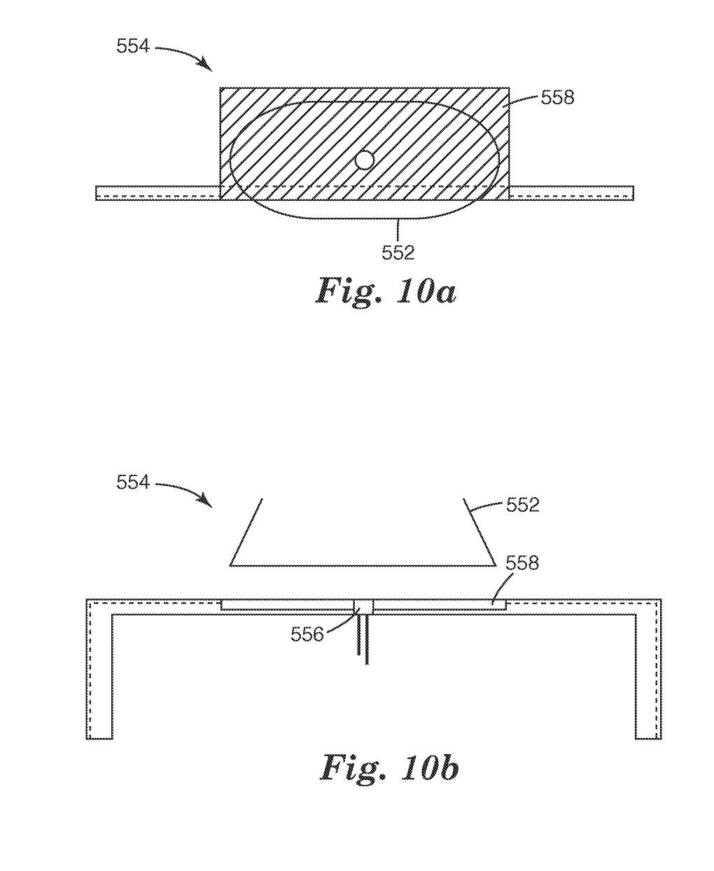

The fuel pressure regulator was adjusted to deliver 6.0 gal./hr. (0.378 L/min.) at an operating fuel pressure of 100 lb./in.2 (0.71 MPa). Calibration rig 554, illustrated in FIGS. 10a and 10b, was constructed to incorporate a calorimeter and thermocouple rake for the measurement of both heat flux and temperature. Calorimeter 556 was a total heat flux, foil type Gardon Gage with a range such as 0-20 Btu/ft2-sec (0-22.7 W/cm2), accurate to ±3% of the indicated reading. The calorimeter was mounted in 12-by 12±0.125 inch (305 by 305±3 mm) by 0.75±0.125 inch (19 mm±3 mm) thick insulating block 558 attached to calibration rig 556 for attachment to test rig 540 during calibration.

Seven ⅛ inch (3.1 mm) ceramic packed, metal sheathed, type K (Chromel-Alumel), grounded junction thermocouples 560 with a nominal 24 American Wire Gauge (AWG) size conductor were provided for calibration. The thermocouples were attached to steel angle bracket 562 to form thermocouple rake 561 for placement in calibration rig 554 during burner calibration.

A vane-type air velocity meter (available under the trade designation “Omega Engineering Model HH30A”) was used to calibrate the velocity of air entering burner 550. An adapter was used to attach the measuring device to the inlet side of burner 550 to prevent air from entering burner 550 other than through the device.

Mounting frame 570 for test specimens 566 was fabricated of ⅛ inch (3.1 mm) thick steel as shown in FIG. 7. Specimen mounting frame stringers 580 (horizontal) were bolted to test frame formers 574 and 576 (vertical) such that the expansion of the stringers would not cause the entire structure to warp. Mounting frame 570 was used for mounting the laminate sheet material test specimens 566 as shown in FIG. 8. Two total heat flux Gardon type calorimeters 556 were mounted above insulation test specimens 566 on the back side (cold) area of the test specimen mounting frame as shown in FIG. 8. The calorimeters were positioned along the same plane as the burner cone centerline, at a distance of 4 inches (212 mm) from the centerline of the test frame.

A computerized data acquisition system was used to measure and record the outputs of the calorimeters and the thermocouples. A stopwatch, accurate to ±1%, was used to measure the time of application of the burner flame and burnthrough time. Tests were performed at a fire test center (that is, a test chamber) having a floor area larger than 10 feet by 10 feet (3.1 meters by 3.1 meters). The test chamber had an exhausting system capable of removing the products of combustion expelled during tests.

The laminate sheet material blanket specimens were 27 inches (686 mm) wide by 36 inches (914 mm) long. Blanket test specimens 566 were attached to test frame 570 using 12 vise grip welding clamps 572. The clamps were used to hold blankets 566 in place in both of the outer vertical formers 574, as well as center vertical former 576 (4 clamps per former). The top and bottom clamps were placed 6 inches (152 mm) from the top and bottom of the test frame, respectively. The middle clamps were placed 8 inches (203 mm) from the top and bottom clamps.

The frame assembly was leveled and centered to ensure alignment of the calorimeter and thermocouple rake with the burner cone. The ventilation hood for the test chamber was turned on. The burner was turned on while the igniter remained off. The fuel flow rate was measured using a 2.0 L graduated cylinder and a 4 minute sampling time.

Calibration rig 554 was positioned adjacent to test specimen frame 570. Burner 550 was positioned so that it was centered in front of the calibration rig, and the vertical plane of burner cone 552 exit was at a distance of 4±0.125 inches (102±3 mm) from the calorimeter face. The horizontal centerline of burner cone 552 was offset 1 inch (25.4 mm) below the horizontal centerline of calorimeter 556.

The air velocity meter was positioned in the adapter. The blower/motor was turned on and adjusted such that the air intake velocity was 2150±50 ft/min (655±15 M/min). Burner 550 was rotated from the test position to the warm-up position. While burner 550 is in the warm up position, blower/motor, igniters, and fuel flow were turned on and the burner ignited and allowed it to warm up for a period of 2 minutes. Burner 550 was rotated into the calibration position and allowed 1 minute for calorimeter stabilization, and the heat flux recorded once every second for a period of 30 seconds. Burner 550 was turned off, rotated out of position, and allowed to cool. The average heat flux was calculated over this 30-second duration. The average heat flux was 15.7 Btu/ft2-sec (17.9 W/cm2) which was in the acceptable range of 16.0±0.8 BTU/ft2-sec (18.2±0.9 W/cm2).

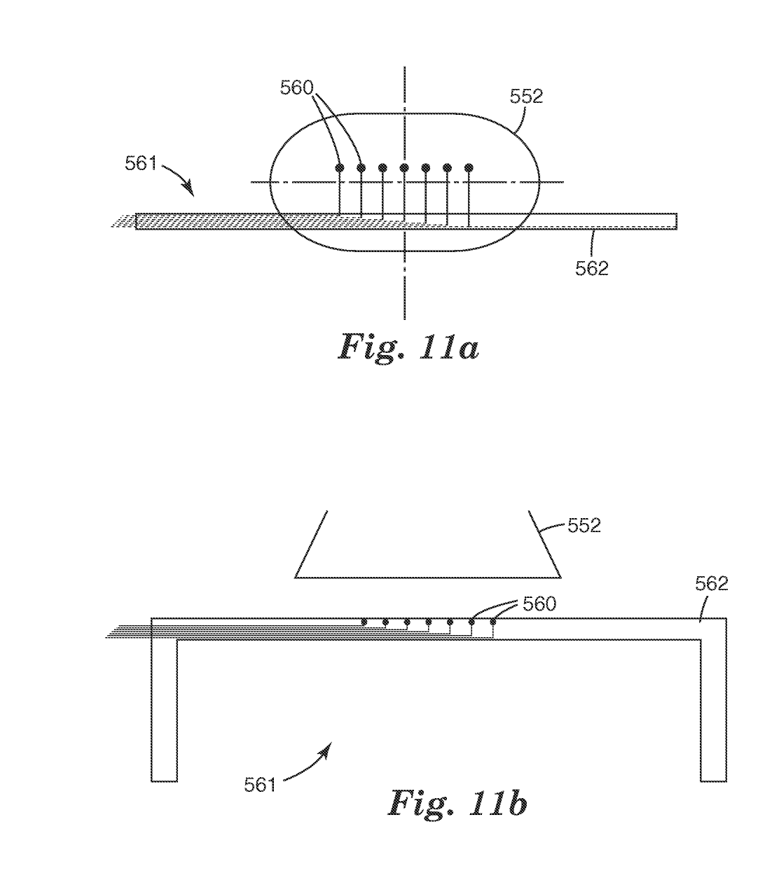

Thermocouple rake 561, illustrated in FIGS. 11a and 11b, was positioned in front of the burner after checking for proper alignment and burner 550 was rotated to the warm-up position. The blower/motor, igniters and fuel flow turned on, burner 550 ignited and allowed to warm up for a period of 2 minutes. Burner 550 was rotated into the calibration position and allow 1 minute for thermocouple 560 stabilization, then the temperature of each of the 7 thermocouples 560 recorded once every second for a period of 30 seconds. Burner 550 was turned off, rotated out of position, and allowed to cool. The average temperature of each thermocouple 560 over this 30-second period was within the acceptable range of 1900° F.±100° F. (1038±38° C.).

Laminate sheet material blanket specimens 566 were secured to the test frame. Laminate sheet material 566 was attached to test rig center vertical former 576 using four welding clamps 572 positioned as shown in FIG. 8a. The vertical plane of the burner cone 552 was at a distance of 4±0.125 inch (102±3.2 mm) from the outer surface of the horizontal stringers of test specimen frame 570, and that burner 550 and test frame 570 were both situated at a 30° angle with respect to vertical. Burner 550 was directed away from the test position to the warm-up position so that the flame did not impinge on the specimens. Burner 550 was ignited and allowed to stabilize for 2 minutes. The test was begun by rotating burner 550 into the test position and simultaneously start the timing device. Test specimens 566 were exposed to the burner flame for 4 minutes and burner 550 turned off. Burner 550 was immediately rotated back to the warm-up position. The burnthrough time, and/or the point at which the heat flux exceeds 2.0 Btu/ft2-sec (2.3 W/cm2) was recorded.

For the sample to pass the Burnthrough Test, laminate sheet material shall resist fire/flame penetration for at least 240 seconds and shall allow no more than 2.0 Btu/ft2-sec (2.3 W/cm2) on the cold side of the insulation specimens at a point 12 inches (301 mm) from the front face of the horizontal stringers of the test rig.

### Comparative Example

An aluminoborosilicate fiber based paper (prepared as described in U.S. Pat. No. 5,955,177 (Sanocki et. al.), but not printed with a metal oxide pattern) having a 35 g/m² basis weight, was infiltrated with a 7.5 wt. % dispersion of vermiculite in water (obtained under the trade designation “MICROLITE 963” from W. R. Grace, Cambridge, Mass. The infiltrated paper was placed on an open mesh belt and dried in a convection oven operating at 90° C. for approximately 30 minutes to remove the water. The dried paper had a basis weight of 55 g/m², and was used to prepare the following laminate.

A four-layer laminate sheet material was prepared using a scrim reinforced metallized polyvinylfloride film (obtained from Chase Corporation, Paterson, N.J., under the trade designation “INSULFAB 331”). The film had of a 12 micrometer metallized polyvinylfloride film with a flame retardant adhesive and a 12×6 nylon scrim bonded to one side of the film. The 12×6 nylon scrim is a 30 Denier warp and 70 Denier fill leno weave (obtained from Textum Weaving, Inc., Belmont, N.C.). The adhesive/scrim side of the film was thermally laminated to the inorganic coated paper described above, using a hot two roll laminator operating at a pressure of 1.1 kg/cm², a temperature of 113° C., and a linear speed of 1.5 m/minute.

The resulting laminate sheet material was tested according to the above-defined Flammability Test and Flame Propagation Test. Three test samples showed no flame propagation and exhibited after flame times of 0, 0, and 0 seconds, which passed the Flammability and Flame Propagation Test.

The laminate sheet material was also tested according to the above-defined Burnthrough Test. The results showed no flame penetration through the specimen in 240 seconds and a maximum heat flux of 1.6 W/cm², thereby passing the Burnthrough Test.

The “Thermal Bond Strength” between the adhesive, scrim side of the four-layer laminate sheet material and adhesive side of the scrim reinforced metallized polyvinylfloride film (“INSULFAB 332”) in the warp direction was determined as follows. 140 mm×120 mm samples were cut from the laminate in 3 areas across the width of the web. Each sample was aligned with a 140 mm×120 mm sample of the scrim reinforced metallized polyvinylfloride film (“INSULFAB 332”) cover film so that the adhesive side of each material faced each other. The two films were then placed approximately 25 mm into the impulse sealer (obtained under the trade designation “VERTROD 14A THERMAL IMPULSE SEALER” from PMC Machinery, San Rafael, Calif.), and sealed at 176° C. for 4 seconds and 482 kPa pressure. The bonded samples were then cut into 25 mm wide strips perpendicular to the bond line and then a T-Peel test was run using a tensile tester with a 75 mm gage length and a cross head speed of 50 mm/min. Results were reported as the average of 3 samples.

The “Ultrasonic Bond Strength” between the adhesive, scrim side of the four-layer laminate sheet material and adhesive side of the scrim reinforced metallized polyvinylfloride film (“INSULFAB 332”) in the warp direction was determined as follows. 140 mm×120 mm samples were cut from the laminate in 3 areas across the width of the web. Each sample was aligned with a 140 mm×120 mm sample of the scrim reinforced metallized polyvinylfloride film (“INSULFAB 332”) cover film so that the adhesive side of each material faced each other. The two films were then placed approximately 25 mm from the edge under the ultrasonic horn in the sealer (obtained under the trade designation “BRANSON F-90” from Branson Worldwide, Danbury, Conn.). The samples were sealed at 60% power setting and a sealing speed of 15.2 cm/sec. The bonded samples were then cut into 25 mm wide strips perpendicular to the bond line and then a T-Peel test was run using a tensile tester with a 75 mm gage length and a cross head speed of 50 mm/min. Results were reported as the average of 3 samples.

This laminate had thermal and ultrasonic seal strengths of less than 4.0 N when sealed to the scrim reinforced metallized polyvinylfloride film (“INSULFAB 332”).

This product is useful as a fuselage burn through barrier. It can be attached, for example, to the outside of the thermal acoustic insulation bag with tape or adhesive. It could also be used as barrier that was inserted inside the thermal acoustic insulation bag.

However, it could not be used as a burn through cover on one side of the thermal acoustic insulation blanket due to poor heat sealing of the laminate to the cover film on the back side of the thermal acoustic insulation blanket. Aircraft manufactures require a minimum heat seal peel strength of 10 N/25 mm width for both ultrasonic and thermal sealing processes.

### Illustrative Example A

A five-layer laminate sheet material was prepared substantially as described in the Comparative Example, except that the scrim reinforced metallized polyvinylfloride film was 6 micrometers thick. The film had a 6 micrometer metallized polyvinylfloride film with a flame retardant adhesive and a 20×10 nylon scrim bonded to one side of the film (obtained from Chase Corporation). The adhesive/scrim side of the film was thermally laminated to the inorganic coated paper described above, using a hot two roll laminator operating at a pressure of 1.1 kg/cm², a temperature of 113° C., and a linear speed of 1.5 m/minute. Then an additional coat of adhesive was applied to the paper side of the laminate using a gravure coating unit produce a laminate with a final aerial density of 113.7 g/m².

The thermal and ultrasonic heat seal bond strengths in the warp direction were determined as described in the Comparative Example to be 5.8 N and 4.9 N, respectively.

### Example 1

A five-layer laminate sheet material was prepared substantially as described in Example 2 except that the 12×6 nylon scrim was moved from between the film and paper to the paper side of the laminate. The film still had a 6 micrometers metallized polyvinylfloride film with a flame retardant adhesive (obtained from Chase Corporation). The adhesive side of the film was thermally laminated to the inorganic coated paper described above, using a hot two roll laminator operating at a pressure of 1.1 kg/cm², a temperature of 113° C., and a linear speed of 1.5 m/minute. Then an additional coat of adhesive and 12×6 scrim was applied to the paper side of the laminate using a gravure coating unit produce a laminate with a final aerial density of 100.2 g/m².

The thermal and ultrasonic heat seal bond strength in the warp direction were determined as described in the Comparative Example to be 10.7 N and 9.8 N, respectively.

### Illustrative Example B

An aluminoborosilicate fiber based paper (prepared as described in U.S. Pat. No. 5,955,177 (Sanocki et. al.), but not printed with a metal oxide pattern) having a 30 g/m² basis weight, was infiltrated with a 7.5 wt. dispersion of vermiculite in water (“MICROLITE 963”). The infiltrated paper was placed on an open mesh belt and dried in a convection oven operating at 90° C. for approximately 30 minutes to remove the water. The dried paper had a basis weight of 40 g/m², and was used to prepare the following laminate.

A five-layer laminate sheet material was prepared using a scrim reinforced metallized polyetheretherketone (PEEK) film (obtained from Chase Corporation under the trade designation “INSULFAB 3333”). The film had of a 6 micrometers metallized PEEK film with a flame retardant adhesive and a 15×7 nylon scrim (30 Denier warp and 70 Denier fill) bonded to one side of the film. The adhesive/scrim side of the film was thermally laminated to the inorganic coated paper described above, using a hot laminator at a pressure of 1.1 kg/cm², a temperature of 113° C., and a linear speed of 1.5 m/minute. Then an additional coat of adhesive was applied to the paper side of the laminate using a gravure coating unit to produce a laminate with a final aerial density of 87.3 g/m².

The thermal and ultrasonic heat seal bond strengths in the warp direction were determined as described in the Comparative Example to be 3.6 N and 3.6 N, respectively.

### Example 2

A five-layer laminate sheet material was prepared using the coated paper from Illustrative Example B, and metallized PEEK film (obtained from Chase Corporation). The film had of a 6 micrometers metallized PEEK film with a flame retardant adhesive bonded to the film. The adhesive side of the film was thermally laminated to the inorganic coated paper described above, using a hot laminator at a pressure of 1.1 kg/cm², a temperature of 113° C., and a linear speed of 1.5 m/minute. Then an additional coat of adhesive and 15×7 nylon scrim was applied to the paper side of the laminate using a gravure coating unit produce a laminate with a final aerial density of 97.6 g/m².

The thermal and ultrasonic seal bond strengths in the warp direction were determined as described in the Comparative Example to be 15.1 N and 12.0 N, respectively.

### Example 3

A five-layer laminate sheet material was prepared using the coated paper from Illustrative Example B, and metallized PEEK (polyetheretherketone) film (obtained from Chase Corporation). The film was a 6 micrometers metallized PEEK film with a flame retardant adhesive bonded to the film. The adhesive side of the film was thermally laminated to the inorganic coated paper described above, using a hot two roll laminator at a pressure of 1.1 kg/cm², a temperature of 113° C., and a linear speed of 1.5 m/minute. Then an additional coat of adhesive and 20×10 scrim was applied to the paper side of the laminate using a gravure coating unit produce a laminate with a final aerial density of 98.8 g/m².

The thermal and ultrasonic heat seal strengths in the warp direction were determined as described in the Comparative Example to be 19.1 N and 16.9 N, respectively.

The resulting laminate sheet material was tested according to the above-defined Flammability Test and Flame Propagation Test. Three test samples showed no flame propagation and exhibited after flame times of 0, 0, and 0 seconds, which passed the Flammability and Flame Propagation Test.

The laminate sheet material was also tested according to the above-defined Burnthrough Test. The results showed no flame penetration through the specimen in 240 seconds and a heat flux of 1.76 W/cm², thereby passing the Burnthrough Test.

Various modifications and alterations of this invention will become apparent to those skilled in the art without departing from the scope and spirit of this invention, and it should be understood that this invention is not to be unduly limited to the illustrative embodiments set forth herein.

1. A flexible laminate sheet material comprising:
a first layer comprised of a film of high temperature stable polymeric material, wherein the high temperature stable polymeric material is stable at a temperature of at least 150° C.;
a second, fabric layer comprised of non-metallic fibers;
a third, scrim layer;
first adhesive disposed between the first and second layers; and
second adhesive disposed between the second and third layers,
wherein the layers are in the following order: first layer, second layer, and third layer, and
wherein the third layer has a first and second generally opposed, major surfaces, the first major face being closer to the second layer than the second major face, and wherein at least a portion of the second major surface is exposed.

2. The flexible laminate sheet material according to claim 1, wherein the first, second, and third layers and first and second adhesives collectively provide the laminate sheet material to have at least one of a passing Flammability Value, a passing Flame Propagation Value, a passing Burnthrough Value, or a combination thereof.

3-6. (canceled)

7. The flexible laminate sheet material according to claim 1, wherein the first layer is a fluid barrier.

8. The flexible laminate sheet material according to claim 1 having a weight up to 150 grams per square meter.

9. The flexible laminate sheet material according to claim 1, wherein the high temperature stable polymeric material is at least one of polyamides, polyvinyl fluorides, silicone resins, polyimides, polytetrafluoroethylenes, polyesters, polyaryl sulfones, polyetheretherketones, polyetherketoneketones, polyester amides, polyester imides, polyethersulfones, or polyphenylene sulfides.

10. The flexible laminate sheet material according to claim 1, wherein the average thickness of the laminate sheet material ranges from 75 to 1200 micrometers.

11. The flexible laminate sheet material according to claim 1 further comprising a material comprising a metal oxide secured to at least a portion of the second layer.

12. The flexible laminate sheet material according to claim 11, wherein the second layer comprises a nonwoven fabric.

13. The flexible laminate sheet material according to claim 12, wherein the nonwoven fabric comprises at least 10% by weight of the non-metallic fibers that are at least 5 millimeters in length.

14. The flexible laminate sheet material according to claim 11, wherein the second layer has a first and second major surface, and wherein the metal oxide is in the form of a coating and present on only a portion of at least one of the major surfaces of the second layer.

15. The flexible laminate sheet material according to claim 14, wherein the metal oxide is arranged in a plurality of islands on the second layer.

16. The flexible laminate sheet material according to claim 14 wherein the metal oxide covers in a range from 5% to 25% of the total surface area of the major surfaces having the metal oxide coating thereon.

17. The flexible laminate sheet material according to claim 1 further comprising inorganic oxide platelets secured to at least a portion of the second layer.

18. The flexible laminate sheet material according to claim 17, wherein the inorganic oxide platelets are at least one of mica platelets, clay platelets, or vermiculite platelets, talc platelets.

19. (canceled)

20. An article comprising the flexible laminate sheet material according to claim 1 and a fourth layer having a major surface at least one of thermally or ultrasonically bonded to the scrim.

21. The article according to claim 20, where the bond between the flexible laminate sheet material and the fourth layer has a Thermal Bond Strength of at least 10 Newton.

22. The article according to claim 20, where the bond between the flexible laminate sheet material and the fourth layer in the warp direction has an Ultrasonic Bond Strength of at least 10 Newton.

23-25. (canceled)

26. The article according to claim 20, wherein the fourth layer comprises an insulation material that is flammable or nonflammable.

27. (canceled)

28. A vehicle comprising the article according to claim 26.

29. An aircraft comprising the article according to claim 26.

30-47. (canceled)
